(19) United States
(12) Patent Application Publication
(10) Pub. No.: US 2013/0312626 A1
(43) Pub. Date: Nov. 28, 2013

(54) BANKNOTE PRINTING MACHINE

(71) Applicant: Hiroyoshi Kamoda, Tsukuba-shi (JP)

(72) Inventor: Hiroyoshi Kamoda, Tsukuba-shi (JP)

(73) Assignee: KOMORI CORPORATION, Tokyo (JP)

(21) Appl. No.: 13/991,030

(22) PCT Filed: Nov. 29, 2011
(86) PCT No.: PCT/JP2011/077461

§ 371 Date: Aug. 14, 2013

(30) Foreign Application Priority Data
Dec. 3, 2010 (JP) 2010-270055
Nov. 14, 2011 (JP) 2011-248390

(51) Int. Cl. B41F 9/00

(52) U.S. Cl. CPC B41F 9/00
USPC 101/216

(57) ABSTRACT

The present invention comprises: one-surface impression cylinders (121a-161a) for holding and transporting a sheet; one-surface rubber cylinders (122a-162a) for printing on a sheet in one direction, the rubber cylinders being in contact with the impression cylinders (121a-161a); one-surface plate cylinders (123a-163a) in contact with the rubber cylinders (122a-162a); one-surface ink devices (124a-164a) for supplying ink to the plate cylinders (123a-163a); other-surface impression cylinders (121b-161b) for receiving, holding, and conveying the sheet from the impression cylinders (121a-161a) in contact with the impression cylinders (121a-161a); other-surface rubber cylinders (122b-162b) for printing on the sheet in the other direction, the other-surface rubber cylinders being in contact with the impression cylinders (121b-161b); other-surface plate cylinders (123b-163b) in contact with the rubber cylinders (122b-162b); and other-surface ink devices (124b-164b) for supplying ink to the plate cylinders (123b-163b).

### TECHNICAL FIELD

The present invention relates to a banknote printing press for printing banknotes such as bank bills.

### BACKGROUND ART

As described for example in Patent Literature 1 listed below and the like, a banknote printing press for printing banknotes such as bank bills employs a simultaneous double-sided printing system which performs offset printing of printing images of a plurality of colors simultaneously on both surfaces of a sheet, by transferring printing images of inks of the respective colors onto two blanket cylinders, which are in contact with each other, from a plurality of inking devices disposed along circumferential directions of the blanket cylinders via corresponding plate cylinders, and by causing the sheet to pass between the blanket cylinders.

### CITATION LIST

### Patent Literatures

### Patent Literature 1: Japanese Patent Application Publication No. 2007-021858

Patent Literature 2: Japanese Patent Application Publication No. Hei 11-105249
Patent Literature 3: Japanese Patent Publication No. Hei 07-002417

### Patent Literature 4: Japanese Patent Application Publication No. 2007-106128

### Patent Literature 5: Japanese Patent No. 2722022

### Patent Literature 6: Japanese Patent No. 4025255

### SUMMARY OF INVENTION

### Technical Problem

Such a banknote printing press as described above, however, performs simultaneous double-sided printing on the sheet by pressing the sheet with the blanket cylinders each having an elastic rubber blanket wound around the surface thereof. For this reason, the banknote printing press is incapable of printing sharp printing images on both surfaces of the sheet.

In view of the above-described circumstances, an object of the present invention is to provide a banknote printing press capable of printing sharp printing images on both surfaces of a sheet.

### Solution to Problem

To solve the above-described problem, a banknote printing press for printing banknotes according to the present invention is characterized in that the banknote printing press comprises: a printing section for one surface including an impression cylinder for one surface which holds and transports a sheet, a blanket cylinder for one surface which is in contact with the impression cylinder for one surface and which performs printing on one surface of the sheet, a plate cylinder for one surface which is in contact with the blanket cylinder for one surface, and ink supply means for one surface for supplying ink to the plate cylinder for one surface; a printing section for the other surface including an impression cylinder for the other surface which is in contact with the impression cylinder for one surface of the printing section for one surface and which receives the sheet from the impression cylinder for one surface and holds and transports the sheet, a blanket cylinder for the other surface which is in contact with the impression cylinder for the other surface and which performs printing on the other surface of the sheet, a plate cylinder for the other surface which is in contact with the blanket cylinder for the other surface, and ink supply means for the other surface for supplying ink to the plate cylinder for the other surface; and sheet delivery means disposed downstream of the printing section for the other surface in a transporting direction of the sheet and including a plurality of piling units on each of which the sheet is to be piled, and each of the ink supply means for one surface of the printing section for one surface and the ink supply means for the other surface of the printing section for the other surface includes: two ink fountains; an oscillating roller; and oscillation adjusting means for adjusting oscillation of the oscillating roller.

In addition, the banknote printing press according to the present invention is characterized in that, in the above-described banknote printing press, the printing section for one surface and the printing section for the other surface are configured as a printing unit of one module, and a plurality of the printing units are capable of being coupled.

In addition, the banknote printing press according to the present invention is characterized in that the above-described banknote printing press further comprises: checking means for one surface for detecting a printing condition of the one surface of the sheet, the checking means for one surface being disposed downstream, in the transporting direction of the sheet, of a printing portion in the printing section for one surface that is located on the most downstream side in the transporting direction of the sheet; and checking means for the other surface for detecting a printing condition of the other surface of the sheet, the checking means for the other surface being disposed downstream, in the transporting direction of the sheet, of a printing portion in the printing section for the other surface that is located on the most downstream side in the transporting direction of the sheet.

In addition, the banknote printing press according to the present invention is characterized in that the above-described banknote printing press further comprises: plate changing means for one surface for changing a printing plate for the plate cylinder for one surface, the plate changing means for one surface being provided in the printing section for one surface; and plate changing means for the other surface for changing a printing plate for the plate cylinder for the other surface, the plate changing means for the other surface being provided in the printing section for the other surface.

### Advantageous Effects of Invention

According to the banknote printing press of the present invention, printing is performed one surface of a sheet held on the impression cylinder for one surface by the blanket cylinder for one surface, the sheet is then gripped and held on the impression cylinder for the other surface, and printing is performed on the other surface of the sheet by the blanket cylinder for the other surface. In short, the banknote printing press employs alternate double-side printing. Therefore, when printing is performed on each of both surfaces of the sheet, the sheet is pressed against the blanket cylinder by the impression cylinder, making it possible to print sharp printing images on both surfaces of the sheet.

### BRIEF DESCRIPTION OF DRAWINGS

FIG. 1 is an overall schematic configuration diagram of a main embodiment of a banknote printing press according to the present invention.

FIG. 2 is an enlarged diagram of an extracted part of FIG. 1.

FIG. 3 is a schematic configuration diagram of a plate clamping device and a printing plate mounting device of a printing section for one surface of the banknote printing press in FIG. 1.

FIG. 4 is a schematic configuration diagram of a plate clamping device and a printing plate mounting device of a printing section for the other surface of the banknote printing press in FIG. 1.

FIG. 5 is a schematic configuration diagram of an oscillation adjusting device for an oscillating roller of the banknote printing press in FIG. 1.

FIG. 6 is a control block diagram of the oscillation adjusting device and a sheet sorting device of the banknote printing press in FIG. 1.

### DESCRIPTION OF EMBODIMENTS

Although embodiments of a banknote printing press according to the present invention will be described on the basis of the drawings, the present invention is not limited to only the embodiments which are described below on the basis of the drawings.

### Main Embodiment

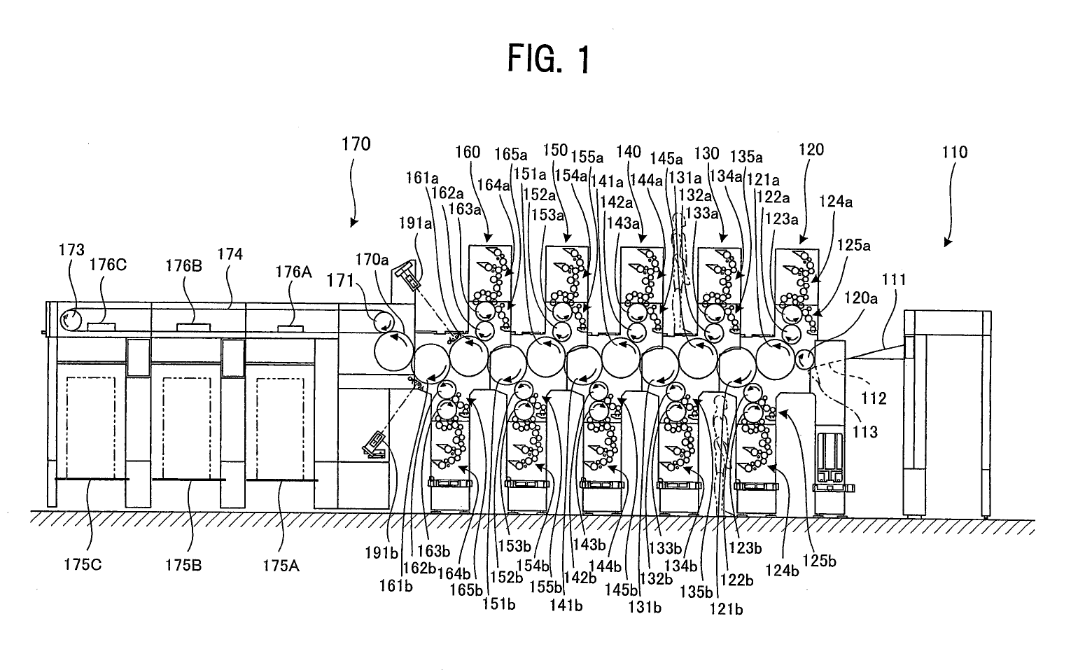

A main embodiment of the banknote printing press according to the present invention will be described on the basis of FIGS. 1 to 6.

### <<Overall Main Configuration>>

As shown in FIG. 1, a feedboard 112 is attached to a leading end side of a feeder board 111 of a sheet feeding device 110, which is sheet feeding means for feeding sheets one by one. A transfer cylinder 120a of a first printing unit 120 is disposed on the leading end side of the feedboard 112. A swing arm shaft pregripper 113 for passing the sheets one by one to the transfer cylinder 120a is provided between the feedboard 112 and the transfer cylinder 120a.

An impression cylinder 121a for one surface of the first printing unit 120 is in contact with the transfer cylinder 120a of the first printing unit 120. A blanket cylinder 122a for one surface is in contact with the impression cylinder 121a. A plate cylinder 123a for one surface is in contact with the blanket cylinder 122a. An inking device 124a for one surface, which is ink supply means for one surface, and a dampening device 125a for one surface, which is a dampening means for one surface, are provided to the plate cylinder 123a. The impression cylinder 121a, the blanket cylinder 122a, the plate cylinder 123a, the inking device 124a, the dampening device 125a, as described above, and the like constitute a printing section for one surface of the first printing unit 120.

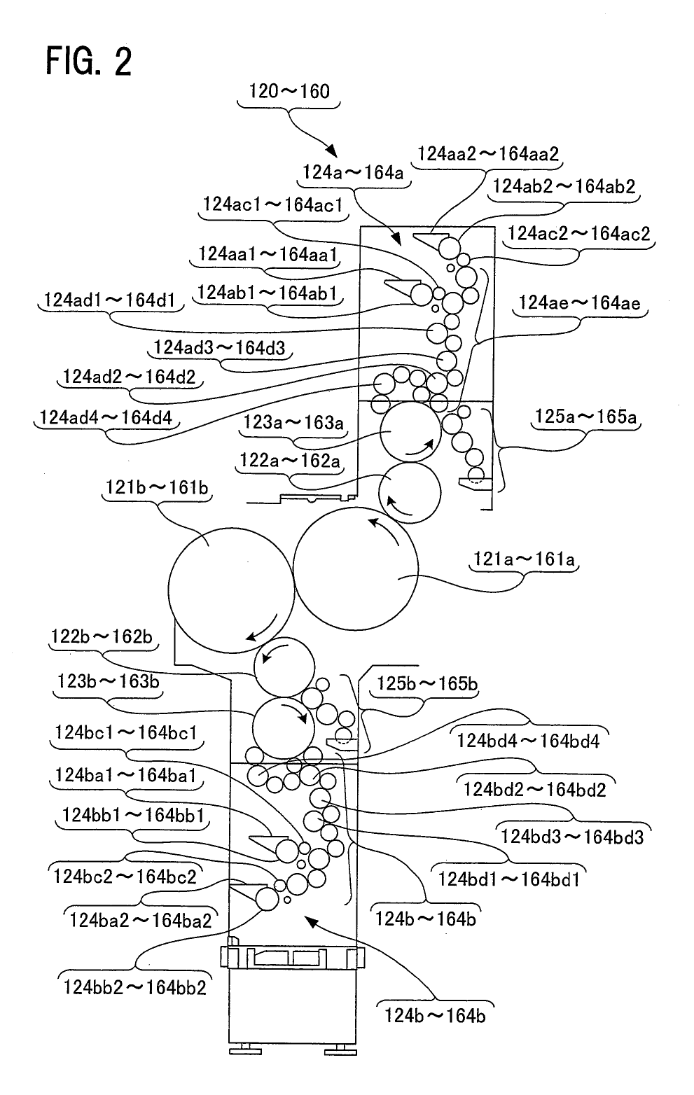

As shown in FIG. 2, the inking device 124a includes: two ink fountains 124aa1 and 124aa2 which are capable of containing inks of colors different from each other; fountain rollers 124ab1 and 124ab2 which take out the ink from the respective ink fountains 124aa1 and 124aa2; ink ductor rollers 124ac1 and 124ac2 which each have a large-diameter portion and a small-diameter portion at predetermined positions in an axial direction thereof and which receive the ink taken out by the respective fountain rollers 124ab1 and 124ab2 on only the large-diameter portions; a roller train 124ae to which the ink is transferred from the large-diameter portions of the ink ductor rollers 124ac1 and 124ac2 and which then sends the ink to the plate cylinder 123a; and oscillating rollers 124ad1 to 124ad4 which are disposed between the rollers of the roller train 124ae and which are capable of reciprocally moving in the axial direction.

As shown in FIG. 1, an impression cylinder 121b for the other surface of the first printing unit 120 is in contact with the impression cylinder 121a at a position downstream of the position where the blanket cylinder 122a is in contact with the impression cylinder 121a in a rotation direction thereof. A blanket cylinder 122b for the other surface is in contact with the impression cylinder 121b. A plate cylinder 123b for the other surface is in contact with the blanket cylinder 122b. An inking device 124b for the other surface, which is ink supply means for the other surface, and a dampening device 125b for the other surface, which is dampening means for the other surface, are provided to the plate cylinder 123b. The impression cylinder 121b, the blanket cylinder 122b, the plate cylinder 123b, the inking device 124b, the dampening device 125b, as described above, and the like constitute a printing section for the other surface of the first printing unit 120.

As shown in FIG. 2, in the same manner as the inking device 124a, the inking device 124b includes: two ink fountains 124ba1 and 124ba2 which are capable of containing inks of colors different from each other; fountain rollers 124bb1 and 124bb2 which take out the ink from the respective ink fountains 124ba1 and 124ba2; ink ductor rollers 124bc1 and 124bc2 which each have a large-diameter portion and a small-diameter portion at predetermined positions in an axial direction thereof and which receive the ink taken out by the respective fountain rollers 124bb1 and 124bb2 on only the large-diameter portions; a roller train 124be to which the ink is transferred from the large-diameter portions of the ink ductor rollers 124bc1 and 124bc2 and which then sends the ink to the plate cylinder 123b; and oscillating rollers 124bd1 to 124bd4 which are disposed between the rollers of the roller train 124be and which are capable of reciprocally moving in the axial direction.

As shown in FIG. 1, an impression cylinder 131a for one surface of a second printing unit 130 is in contact with the impression cylinder 121b for the other surface of the first printing unit 120 at a position downstream of the position where the blanket cylinder 122b is in contact with the impression cylinder 121b in a rotation direction thereof. In the same manner as the first printing unit 120, the second printing unit 130 includes a blanket cylinder 132a, a plate cylinder 133a, an inking device 134a, a dampening device 135a, and the like for one surface, which constitute a printing section for one surface thereof, and includes a blanket cylinder 132b, a plate cylinder 133b, an inking device 134b, a dampening device 135b, and the like for the other surface, which constitute a printing section for the other surface thereof.

An impression cylinder 141a for one surface of a third printing unit 140 is in contact with the impression cylinder 131b for the other surface of the second printing unit 130 at a position downstream of the position where the blanket cylinder 132b is in contact with the impression cylinder 131b in a rotation direction thereof. In the same manner as the first and second printing units 120 and 130, the third printing unit 140 includes a blanket cylinder 142a, a plate cylinder 143a, an inking device 144a, and a dampening device 145a, and the like for one surface, which constitute a printing section for one surface thereof, and includes a blanket cylinder 142b, a plate cylinder 143b, an inking device 144b, and a dampening device 145b for the other surface, which constitute a printing section for the other surface thereof.

An impression cylinder 151a for one surface of a fourth printing unit 150 is in contact with the impression cylinder 141b for the other surface of the third printing unit 140 at a position downstream of the position where the blanket cylinder 142b is in contact with the impression cylinder 141b in a rotation direction thereof. In the same manner as the first to third printing units 120, 130, and 140, the fourth printing unit 150 includes a blanket cylinder 152a, a plate cylinder 153a, an inking device 154a, and a dampening device 155a for one surface, which constitute a printing section for one surface thereof, and includes a blanket cylinder 152b, a plate cylinder 153b, an inking device 154b, and a dampening device 145b for the other surface, which constitute a printing section for the other surface thereof.

An impression cylinder 161a for one surface of a fifth printing unit 160 is in contact with the impression cylinder 151b for the other surface of the fourth printing unit 150 at a position downstream of the position where the blanket cylinder 152b is in contact with the impression cylinder 151b in a rotation direction thereof. In the same manner as the first to fourth printing units 120, 130, 140, and 150, the fifth printing unit 160 includes a blanket cylinder 162a, a plate cylinder 163a, an inking device 164a, and a dampening device 165a for one surface, which constitute a printing section for one surface thereof, and includes a blanket cylinder 162b, a plate cylinder 163b, an inking device 164b, and a dampening device 165b for the other surface, which constitute a printing section for the other surface thereof.

A transport cylinder 170a of a delivery device 170, which is sheet delivery means, is in contact with the impression cylinder 161b for the other surface of the fifth printing unit 160 at a position downstream of the position where the blanket cylinder 162b is in contact with the impression cylinder 161b in a rotation direction thereof. A delivery cylinder 171 is in contact with the transport cylinder 170a. One (not shown) of a pair of sprockets is provided coaxially to the delivery cylinder 171. A delivery chain 174 provided with a plurality of unillustrated gripper bars is looped between the one sprocket and the other sprocket 173. A plurality of delivery piles 175A to 175C (three in the embodiment), each of which is a piling unit, are arranged in a running direction of the delivery chain 174 below the region between the paired one sprocket and other sprocket 173.

Then, each of the first to fifth printing units 120, 130, 140, 150, and 160 constitutes one module including the printing section for one surface and the printing section for the other surface, and a plurality of the units are capable of being coupled and installed. Accordingly, the maximum number of colors required for printing can be easily set by changing the number of units.

### <<Plate Clamping Device of Plate Cylinder>>

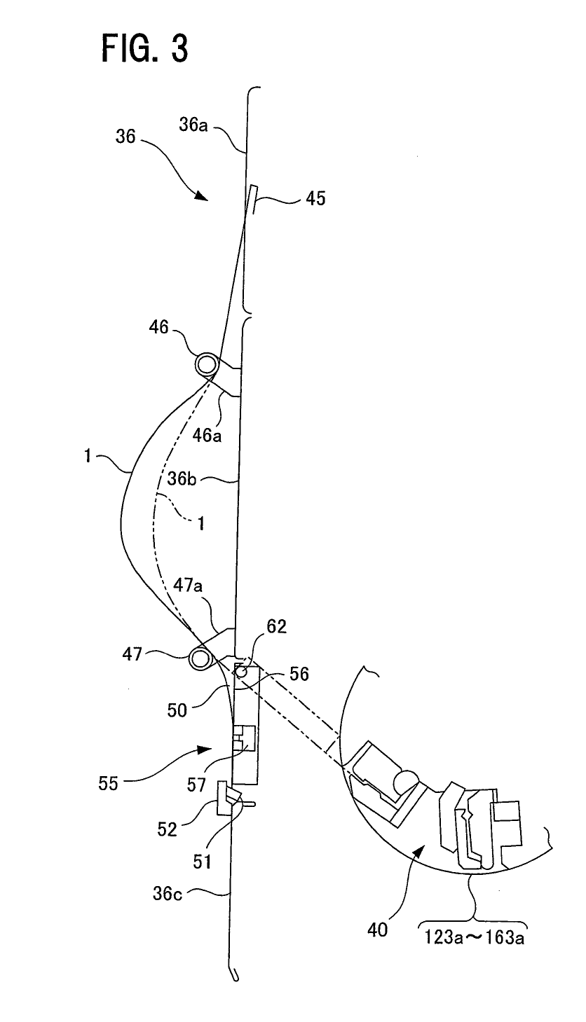

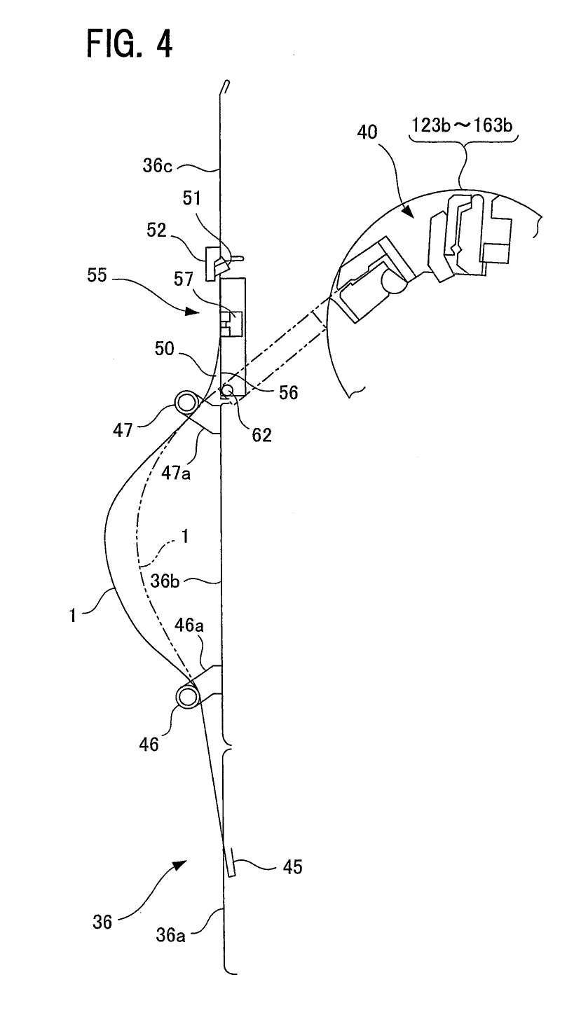

In addition, as shown in FIGS. 3 and 4, the plate cylinders 123a, 133a, 143a, 153a, and 163a for one surface and the plate cylinders 123b, 133b, 143b, 153b, and 163b for the other surface of the printing units 120, 130, 140, 150, and 160 each include a plate clamping device 40 described in the aforementioned Patent Literature 3 and the like. Each plate cylinder is thus capable of detachably holding a printing plate, such as a resin plate or a PS plate, on a peripheral surface of the plate cylinder by means of the plate clamping device 40.

### <<Printing Plate Mounting Device>>

Moreover, the printing units 120, 130, 140, 150, and 160 each include printing plate mounting devices, described in the aforementioned Patent Literatures 4 and 5 and the like, near the plate cylinders 123a and 123b, 133a and 133b, 143a and 143b, 153a and 153b, or 163a and 163b. Thus, it is possible to semi-automatically mount the printing plate on each plate cylinders 123a, 133a, 143a, 153a, or 163a for one surface via the plate clamping device 40 by means of the printing plate mounting device (plate changing means for one surface) provided near the plate cylinder 123a, 133a, 143a, 153a, or 163a while it is possible to semi-automatically mount the printing plate on each plate cylinder 123b, 133b, 143b, 153b, or 163b for the other surface via the plate clamping device 40 by means of the printing plate mounting device (plate changing means for the other surface) provided near the plate cylinder 123b, 133b, 143b, 153b, or 163b.

Specifically, as shown in FIG. 3, a locking portion 45 is provided in an upper cover 36a of a safety cover 36 covering a front surface of the printing section for one surface of each of the printing units 120, 130, 140, 150, and 160. The locking portion 45 is formed in an inverted L-shape in a side view and is configured to lock an end portion of a new plate 1 on the trailing edge side. Reference signs 46 and 47 denote a pair of guide bars each formed in a bar shape. These guide bars 46 and 47 are supported, each at two ends thereof, respectively on upper and lower sides of a middle cover 36b of the safety cover 36 by supporting members 46a and 47a, in parallel with an outer surface of the middle cover 36b at an interval therebetween, and such that the axes of the guide bars 46 and 47 extend in a width direction of the middle cover 36b.

A window 50 formed in a rectangle extending in a left-right direction is provided in an upper portion of a lower cover 36c of the safety cover 36. A pair of left and right positioning pins 51 are fixed to the lower cover 36c via a supporting plate 52 at positions corresponding to lower end portions of the window 50. As shown in the same drawing, the new plate 1 is engaged with the positioning pins 51 to thus support a lower end of the new plate 1 with the positioning pins 51 so that the new plate 1 can be supported by the safety cover 36 before being mounted on the plate cylinder 123a, 133a, 143a, 153a, or 163a.

A plate feeding unit 55 as a swing member generally includes: a swing plate 56 which selectively covers the window 50; and a suction pad 57 which sucks the new plate 1. A large number of holes, through which the suction pad 57 is exposed, are provided in a lower portion of the swing plate 56. The swing plate 56 is supported on the middle cover 36b in such a manner as to be swingable about a pivot shaft 62 implanted on the lower cover 36c as the turning center. The suction pad 57 is supported in such a manner as to be movable on the back surface side of the swing plate 56 along a radial direction of the pivot shaft 62, and is supplied with a suction air from an air intake pump whose illustration is omitted.

The new plate 1 is mounted in the following manner by the printing plate mounting device configured as described above. First, the end portion to be gripped (lower end portion in the drawing) of the new plate 1 is engaged with the positioning pins 51, so that the lower end of the new plate 1 is supported with the positioning pins 51. Next, the upper portion and the lower portion of the new plate 1 are placed into contact with the pair of guide bars 46 and 47. Thereafter, the upper end of the new plate 1 is engaged with the locking portion 45, so that the new plate 1 is supported by the safety cover 36. The new plate 1 thus supported is bent largely in the side view between the pair of guide bars 46 and 47. In this state, the lower end portion of the new plate 1 is sucked by the suction pad 57 of the plate feeding unit 55.

Then, the plate feeding unit 55 is turned about the pivot shaft 62 serving as the turning center in the counterclockwise direction in the drawing to bring the lower end of the plate feeding unit 55 near the plate cylinder 123a, 133a, 143a, 153a, or 163a, so that the plate feeding unit 55 is positioned at an insertion position. In this event, the movement of the plate feeding unit 55 to the insertion position is utilized to release the engagement of the new plate 1 and the positioning pins 51. This configuration eliminates the need of dedicated drive means for moving the positioning pins 51, thus simplifying the device and reducing the manufacturing costs.

Subsequently, the suction pad 57 is moved to be brought near the plate cylinder 123a, 133a, 143a, 153a, or 163a to insert the lower end (end portion to be gripped) of the new plate 1 into the inside, on the gripping side, of the plate clamping device 40 of the plate cylinder 123a, 133a, 143a, 153a, or 163a. Thereafter, the suction of the new plate 1 by the suction pad 57 is released, and thereby the lower end (end portion to be gripped) of the new plate 1, which has been held in the bending state by the suction pad 57, is pressed against the inside, on the gripping side, of the plate clamping device 40 of the plate cylinder 123a, 133a, 143a, 153a, or 163a by an elastic returning force generated by the bending, so that the new plate 1 is positioned.

On the other hand, as shown in FIG. 4, the printing section for the other surface of each printing unit 120, 130, 140, 150, or 160 is provided with a printing plate mounting device, which has a structure obtained by turning upside down the structure of the printing plate mounting device provided in the printing section for one surface. The printing plate mounting device of the printing section for the other surface is capable of operating in the same manner as that of the above-described printing plate mounting device of the printing section for one surface, thereby mounting the new plate 1 on the plate cylinder 123a, 133a, 143a, 153a, or 163a.

### <<Oscillation Adjusting Device for Oscillating Roller>>

Moreover, the oscillating rollers 124ad1 to 124ad4, 134ad1 to 134ad4, 144ad1 to 144ad4, 154ad1 to 154ad4, and 164ad1 to 164ad4 of the inking devices 124a, 134a, 144a, 154a, and 164a for one surface as well as the oscillating rollers 124bd1 to 124bd4, 134bd1 to 134bd4, 144bd1 to 144bd4, 154bd1 to 154bd4, and 164bd1 to 164bd4 of the inking devices 124b, 134b, 144b, 154b, and 164b for the other surface, of the printing units 120, 130, 140, 150, and 160 are configured such that the oscillations of the oscillating rollers are adjustable for each of the inking devices 124a, 124b, 134a, 134b, 144a, 144b, 154a, 154b, 164a, and 164b of the printing units 120, 130, 140, 150, and 160 by an oscillation adjusting device described in the aforementioned Patent Literature 6 and the like.

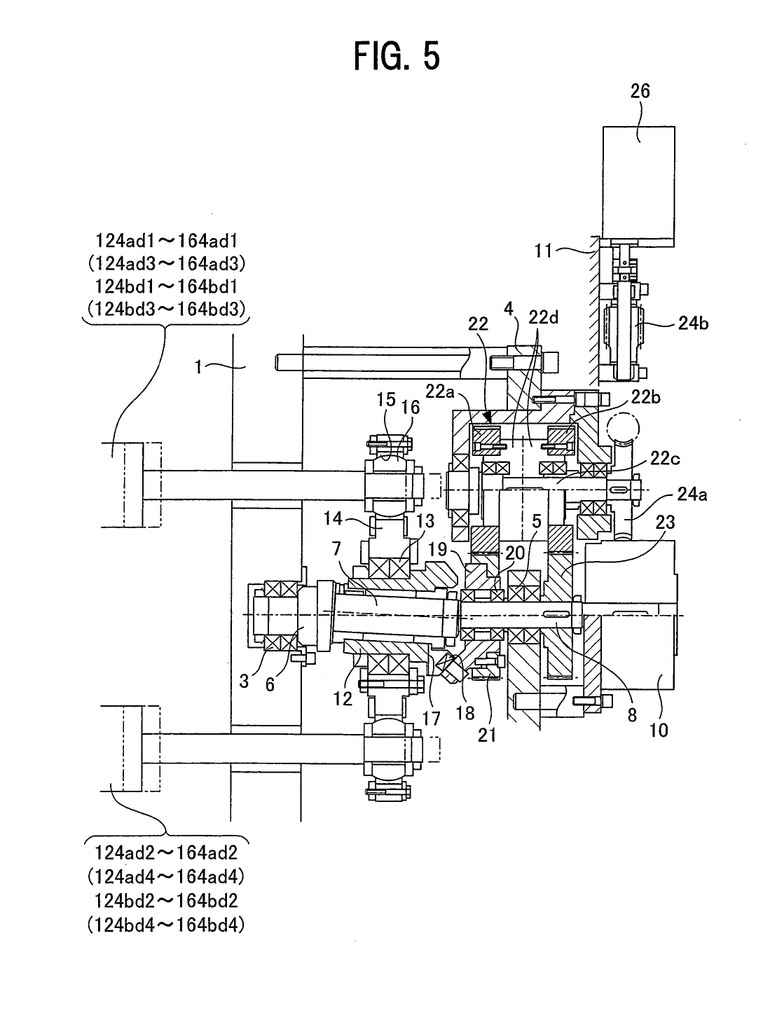

Specifically, as shown in FIG. 5, each of the oscillating rollers 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, and 124bd4 to 164bd4 is rotatably supported on the frame 1 with a shaft. A rotary shaft 6, which is rotatably supported by a bearing 3 provided in the frame 1 and a bearing 5 of a first support plate 4 screwed to the frame 1, is provided in a center portion substantially the same distance from the oscillating rollers 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, and 124bd4 to 164bd4.

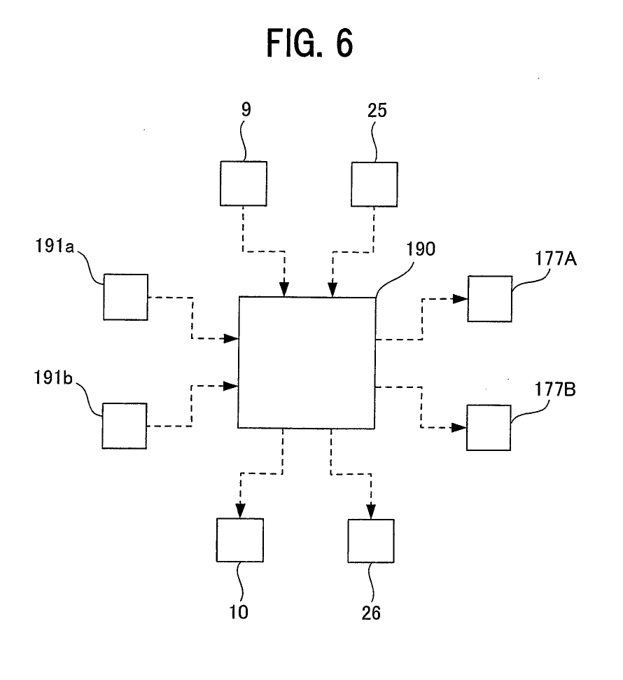

The rotary shaft 6 includes an inclined shaft portion 7 and a parallel shaft portion 8 arranged adjacent to each other. The inclined shaft portion 7 is configured to be inclined to the axis of the oscillating roller 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, or 124bd4 to 164bd4 while the parallel shaft portion 8 has an axis parallel to the axis of the oscillating roller 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, or 124bd4 to 164bd4. At the parallel shaft portion 8, the rotary shaft 6 is supported on the first support plate 4 and is directly connected to an oscillation drive motor (first drive means, a dedicated motor) 10 incorporating a rotary encoder 9 (see FIG. 6), which is formed by a disk servo-motor or the like. The oscillation drive motor 10 is laterally attached to a second support plate 11 screwed to the first support plate 4.

A cylindrical sleeve 12, which has an outer peripheral surface inclined to the axis of the inclined shaft portion 7 of the rotary shaft 6, is fitted on the inclined shaft portion 7 in such a manner as to be rotatable but not movable in the axial direction. A disk (oscillating roller engagement member) 14 is supported on the outer peripheral surface of the sleeve 12 via a bearing 13 in such a manner as to be rotatable but not movable in the axial direction. A spherical body 16 provided on a shaft end of each oscillating rollers 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, or 124bd4 to 164bd4 is fitted to a spherical bearing (engaging portion) 15 provided on an outer peripheral portion of the disk 14.

A fitting groove (engaging portion) 17 is formed in a part of an outer periphery of the sleeve 12. A rotating member 19 having a fitting protrusion (engaged portion, such as a square pin, a round pin, a cam follower, or the like) 18 to be fitted into the fitting groove 17 is rotatably supported on the parallel shaft portion 8 of the rotary shaft 6 via a bearing 20.

An annular gear 21 is fitted on an outer periphery of the rotating member 19. An output gear 22a of a harmonic drive (registered trademark) device 22, serving as a differential mechanism, mounted on the first support plate 4 is in mesh with the annular gear 21. On the other hand, an input gear 22b of the harmonic drive (registered trademark) device 22 is in mesh with a disk-shaped gear 23 fixedly provided on the parallel shaft portion 8 of the rotary shaft 6. In addition, the rotation of an oscillation adjusting motor (second drive means, a dedicated motor) 26 incorporating a potentiometer 25 (see FIG. 6), which is vertically attached to the second support plate 11, is transmitted to a wave generator 22c of the harmonic drive (registered trademark) device 22 via a worm wheel 24a and a worm 24b.

The harmonic drive (registered trademark) device 22 is a known differential mechanism including, as basic elements: the wave generator 22c; a flex spline (not shown) fitted on an outer periphery of the wave generator 22c; and a pair of circular splines 22d in mesh with an outer periphery of the flex spline, in which the number of teeth of the circular splines 22d is two more than the number of teeth of the flex spline, and the output gear 22a is screwed into one of the circular splines 22d while the input gear 22b is screwed into the other circular spline 22d, and the reduction ratio is determined by the numbers of teeth of the flex spline and the circular splines 22d.

Accordingly, during normal operation, stopping the oscillation adjusting motor 26 transmits the rotation of the oscillation drive motor 10 to the disk-shaped gear 23→the harmonic drive (registered trademark) device 22→the annular gear 21 and the rotating member 19 in a ratio of 1:1, so that the sleeve 12, which rotates integrally with the rotating member 19, rotates at the same number of revolutions as that of the rotary shaft 6. On the other hand, rotating the oscillation adjusting motor 26 generates a slight difference in rotation between the disk-shaped gear 23, which is rotated by the oscillation drive motor 10, and the annular gear 21 and rotating member 19 due to the reduction action of the harmonic drive (registered trademark) device 22. The slight difference in rotation causes phase adjustment between the rotary shaft 6 (inclined shaft portion 7) and the sleeve 12, so that the oscillation of each oscillating roller 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, or 124bd4 to 164bd4 is adjusted. After the adjustment, stopping the oscillation adjusting motor 26 causes the number of revolutions of the sleeve 12 to return to the initial number of revolutions (the same number of revolutions as that of the rotary shaft 6).

Further, as shown in FIG. 6, the rotary encoder 9 and the potentiometer 25 are electrically connected to an input unit of a control device 190, which is control means. An output unit of the control device 190 is electrically connected to the motors 10 and 26. The control device 190 is thus capable of controlling the operations of the motors 10 and 26 on the basis of signals from the rotary encoder 9 and the potentiometer 25.

During normal operation, the oscillation adjusting device configured as described above rotates the oscillation drive motor 10 in a state where the oscillation adjusting motor 26 is stopped. This causes the sleeve 12 to rotate at the same number of revolutions as that of the rotary shaft 6 (inclined shaft portion 7) and the disk 14 to precess in conjunction with the precession of the inclined shaft portion 7, as described above. As a result, the oscillating rollers 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, and 124bd4 to 164bd4 are caused to oscillate in the axial direction sequentially at different phases and in a predetermined oscillation.

In this event, after initial position synchronization is performed between the initial position of the oscillation drive motor 10 and the initial position of the prime motor, the initial position of the oscillation drive motor 10 is shifted by a predetermined amount from the initial position of the prime motor, thereby adjusting the oscillation phase of each of the oscillating rollers 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, and 124bd4 to 164bd4 to a predetermined oscillation phase.

Then, under the above-described conditions, rotating the oscillation adjusting motor 26 causes a slight difference in rotation between the disk-shaped gear 23, which is rotated by the oscillation drive motor 10, and the annular gear 21 and rotating member 19 due to the action of the harmonic drive (registered trademark) device 22. The slight difference in rotation causes phase adjustment between the rotary shaft 6 (inclined shaft portion 7) and the sleeve 12, so that the oscillation of each oscillating roller 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, or 124bd4 to 164bd4 is changed by the amount of rotation of the oscillation adjusting motor 26. As a result, the oscillation of the oscillating roller 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, or 124bd4 to 164bd4 is adjusted to the predetermined oscillation.

### <<Sheet Sorting Device>>

In addition, as shown in FIG. 1, release cams 176A to 176C, which are release means for releasing gripper devices of the gripper bars of the delivery chain 174, are disposed near the delivery chain 174 on the respective delivery piles 175A to 175C of the delivery device 170. Elevating devices (see FIG. 6) 177A and 177B, such as air cylinders, which are approach and separation means, are coupled respectively to the two release cams 176A and 176B located closer to the delivery cylinder 171 among the release cams 176A to 176C. The elevating devices 177A and 177B are configured to move up and down to cause the corresponding release cams 176A and 176B to approach or separate from the delivery chain 174.

Moreover, a checking camera 191a for one surface, which is checking means for one surface for detecting a printing condition of one surface of the sheet, is disposed on a downstream side, in the transporting direction of the sheet, of a position (printing portion) where the impression cylinder 161a and the blanket cylinder 162a for one surface of the fifth printing unit 160 are in contact with each other. A checking camera 191b for the other surface, which is checking means for the other surface for detecting a printing condition of the other surface of the sheet, is disposed on a downstream side, in the transporting direction of the sheet, of a position (printing portion) where the impression cylinder 161b and the blanket cylinder 162b for the other surface of the fifth printing unit 160 are in contact with each other.

As shown in FIG. 6, the checking cameras 191a and 191b are electrically connected to the input unit of the control device 190. The output unit of the control device 190 is electrically connected to the elevating devices 177A and 177B. The control device 190 is thus capable of causing the elevating devices 177A and 177B to move up and down on the basis of signals from the checking cameras 191a and 191b.

### <<Printing Operation>>

Next, an operation of the banknote printing press according to the embodiment will be described.

When the sheet is fed one by one from the sheet feeding device 110, the sheet is transferred from the feeder board 111, the feedboard 112, and the swing arm shaft pregripper 113, through the transfer cylinder 120a of the first printing unit 120, to the impression cylinder 121a. As a result, the sheet is held on the impression cylinder 121a with the one surface being on the front side.

The inks filled in the respective ink fountains 124aa1 and 124aa2 of the inking device 124a are taken out by the respective fountain rollers 124ab1 and 124ab2, and are transported to the roller train 124ae by the respective ink ductor rollers 124ac1 and 124ac2. Then, part of the inks is mixed into a rainbow state by the above-described reciprocating motions of the oscillating rollers 124ad1 to 124ad4 in the axial direction, and transported to the plate cylinder 123a. The ink is thus transferred onto the blanket cylinder 122a with a printing image corresponding to the pattern of the plate cylinder 123a.

Then, the sheet passes between the impression cylinder 121a and the blanket cylinder 122a, and thereby the ink, which has been transferred in the rainbow state on the surface of the blanket cylinder 122a, is transferred onto one surface of the sheet held on the peripheral surface of the impression cylinder 121a.

The sheet with the one surface subjected to rainbow printing on the impression cylinder 121a is transported to and gripped on the impression cylinder 121b, so that the sheet is held on the impression cylinder 121b with the other surface being on the front side.

Moreover, the inks filled in the respective ink fountains 124ba1 and 124ba2 of the inking device 124b are taken out by the respective fountain rollers 124bb1 and 124bb2, and are transported to the roller train 124be by the respective ink ductor rollers 124bc1 and 124bc2. Then, part of the inks is mixed into a rainbow state by the above-described reciprocating motions of the oscillating rollers 124bd1 to 124bd4 in the axial direction, and transported to the plate cylinder 123b. The ink is thus transferred onto the blanket cylinder 122b with a printing image corresponding to the pattern of the plate cylinder 123b.

Then, the sheet passes between the impression cylinder 121b and the blanket cylinder 122b, and thus the ink, which has been transferred in the rainbow state on the surface of the blanket cylinder 122b, is transferred onto the other surface of the sheet held on the peripheral surface of the impression cylinder 121b.

The sheet with the other surface subjected to rainbow printing on the impression cylinder 121b is transported to and gripped on the impression cylinder 131a of the second printing unit 130, so that the sheet is held on the impression cylinder 131a with the one surface being on the front side.

Successively, the sheet is subjected to rainbow printing on the one surface and subjected to rainbow printing on the other surface in the second printing unit 130 in the same manner as the first printing unit 120, and then is transferred to the third printing unit 140.

Thereafter, the sheet is subjected to rainbow printing in the third to fifth printing units 140, 150, and 160 in the same manner as the first printing unit 120.

The sheet is subjected to rainbow printing on the one surface while being held on the impression cylinder 161a of the fifth printing unit 160 located on the most downstream side in the transporting direction. Then, the printing condition of the one surface of the sheet is detected by the checking camera 191a. Thereafter, the sheet is transferred to the impression cylinder 161b, and is subjected to rainbow printing on the other surface while being held on the impression cylinder 161b. Then, the printing condition of the other surface of the sheet is detected by the checking camera 191b. Then, the sheet is transported through the transport cylinder 170a of the delivery device 170, and is held and transported by the gripper bar of the delivery chain 174.

The control device 190 judges whether or not the printing conditions of the one surface and the other surface of the sheet are appropriate on the basis of signals from the checking cameras 191a and 191b. When judging that the printing conditions of both the one surface and the other surface of the sheet are appropriate, the control device 190 activates one of the elevating devices 177A and 177B to cause a corresponding one of the release cams 176A and 176B to approach the delivery chain 174, and activates the other one of the elevating devices 177A and 177B to cause the corresponding other one of the release cams 176A and 176B to separate from the delivery chain 174.

In this way, the gripper device of the gripper bar of the delivery chain 174, which is holding and transporting the sheet, comes into contact with one of the release cams 176A and 176B and is thus released, so that the sheet is delivered and piled on a corresponding one of the delivery piles 175A and 175B (the delivery pile located below the one of the release cams 176A and 176B).

Once the number of sheets piled on the one of the delivery piles 175A and 175B as described above reaches a predetermined number, the control device 190 activates the other one of the elevating devices 177A and 177B to cause the corresponding other one of the release cams 176A and 176B to approach the delivery chain 174, and activates the one of the elevating devices 177A and 177B to cause the corresponding one of the release cams 176A and 176B to separate from the delivery chain 174.

In this way, the gripper device of the gripper bar of the delivery chain 174, which is holding and transporting the sheet, comes into contact with the other one of the release cams 176A and 176B and is thus released, so that the sheet is delivered and piled on the other one of the delivery piles 175A and 175B (the delivery pile located below the other one of the release cams 176A and 176B). Accordingly, after the delivery pile to pile the sheets is switched, the sheets piled up to the predetermined number on the one of the delivery piles 175A and 175B can be carried out. Therefore, the printing products can be carried out without stopping the printing on the sheets.

On the other hand, when judging that the printing condition of any of the one surface and the other surface of the sheet is not appropriate, the control device 190 activates the elevating devices 177A and 177B to cause the release cams 176A and 176B to separate from the delivery chain 174.

In this way, the sheet held by the gripper device of the gripper bar of the delivery chain 174 passes through above the delivery piles 175A and 175B without being delivered onto the delivery piles 175A and 175B. Then, the gripper device comes into contact with the release cam 1760 and is released, so that the sheet is delivered on the delivery pile 175C and piled as a wasted sheet.

Therefore, the banknote printing press according to the embodiment can provide the following advantageous effects.

(1) One surface of a sheet held on the impression cylinder 121a, 131a, 141a, 151a, or 161a with the one surface being on the front side is subjected to offset printing by the blanket cylinder 122a, 132a, 142a, 152a, or 162a, and then, the other surface of the sheet, which is then gripped and held on the impression cylinder 121b, 131b, 141b, 151b, or 161b with the other surface being on the front side, is subjected to offset printing by the blanket cylinder 122b, 132b, 142b, 152b, or 162b. In short, the banknote printing press employs alternate double-sided printing. Therefore, when the offset printing is performed on each of both surfaces of the sheet, the sheet is pressed against the blanket cylinder 122a, 132a, 142a, 152a, 162a, 122b, 132b, 142b, 152b, and 162b by the respective impression cylinder 121a, 131a, 141a, 151a, 161a, 121b, 131b, 141b, 151b, and 161b, making it possible to perform offset-printing of sharp printing images on both surfaces of the sheet.
(2) The plate cylinders 123a, 123b, 133a, 133b, 143a, 143b, 153a, 153b, 163a, and 163b each include the plate clamping device 40 described in the aforementioned Patent Literature 3 and the like. Therefore, a printing plate, such as a resin plate or a PS plate, can be easily held detachably on the peripheral surface of each plate cylinder.
(3) The printing units 120, 130, 140, 150, and 160 each include the printing plate mounting device described in the aforementioned Patent Literatures 4 and 5 and the like. Therefore, a printing plate, such as a resin plate or a PS plate, can be easily mounted on each of the plate cylinders 123a, 123b, 133a, 133b, 143a, 143b, 153a, 153b, 163a, and 163b, making it possible to significantly reduce the burden on the worker.
(4) The inking devices 124a, 134a, 144a, 154a, and 164a for one surface and the inking devices 124b, 134b, 144b, 154b, and 164b for the other surface each include the two ink fountains 124aa1 to 164aa1, 124aa2 to 164aa2, 124ba1 to 164ba1, 124ba2 to 164ba2, the fountain rollers 124ab1 to 164ab1, 124ab2 to 164ab2, 124bb1 to 164bb1, 124bb2 to 164bb2, the ink ductor rollers 124ac1 to 164ac1, 124ac2 to 164ac2, 124bc1 to 164bc1, 124bc2 to 164bc2, and the oscillating rollers 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, 124bd4 to 164bd4. In addition, the oscillating rollers 124ad1 to 164ad1, 124ad2 to 164ad2, 124ad3 to 164ad3, 124ad4 to 164ad4, 124bd1 to 164bd1, 124bd2 to 164bd2, 124bd3 to 164bd3, 124bd4 to 164bd4 are each configured such that the oscillation thereof can be adjusted by the oscillation adjusting device described in the aforementioned Patent Literature 6 and the like. Therefore, an ink distribution appropriate for rainbow printing can be easily obtained.
(5) The printing conditions of the one surface and the other surface of the sheet with the one surface and the other surface subjected to printing in the fifth printing unit 160, that is, the printing conditions of the one surface and the other surface of the sheet subjected to printing in the printing section for one surface and the printing section for the other surface which are located on the most downstream side in the transporting direction, are detected respectively by the checking cameras 191a and 191b. The control device 190 then controls the operations of the elevating devices 177A and 177B on the basis of signals from the checking cameras 191a and 191b, such that the sheets are sorted to be piled on the delivery piles 175A and 175B for appropriately printed sheets and the delivery pile 175C for wasted sheets. Therefore, the working efficiency can be improved.
(6) Each combination of the impression cylinder 121a, 121b, 131a, 131b, 141a, 141b, 151a, 151b, 161a, or 161b and the blanket cylinder 122a, 122b, 132a, 132b, 142a, 142b, 152a, 152b, 162a, or 162b is provided with the plate cylinder 123a, 123b, 133a, 133b, 143a, 143b, 153a, 153b, 163a or 163b and the inking device 124a, 124b, 134a, 134b, 144a, 144b, 154a, 154b, 164a, or 164b. Accordingly, a space is provided between the plate cylinder 123a, 123b, 133a, 133b, 143a, 143b, 153a, 153b, 163a or 163b and the inking device 124a, 124b, 134a, 134b, 144a, 144b, 154a, 154b, 164a, or 164b which are adjacent to each other. This eliminates the need for securing a working space for performing the printing preparation work or the maintenance and inspection work, such as the refilling of the ink, the cleaning of the rubber blanket, and the changing of the printing plate, thus allowing the work to be easily performed. In addition, since the plate cylinders 123a, 123b, 133a, 133b, 143a, 143b, 153a, 153b, 163a and 163b the inking devices 124a, 124b, 134a, 134b, 144a, 144b, 154a, 154b, 164a, and 164b, and the like are arranged side by side in the horizontal direction, this allows the worker to perform the work at ease. Therefore, the burden on the worker can be significantly reduced.
(7) Each of the printing units 120, 130, 140, 150, and 160 is configured of a module formed by providing each combination of the impression cylinder 121a, 131a, 141a, 151a, or 161a and the blanket cylinder 122a, 132a, 142a, 152a, or 162a for one surface and the impression cylinder 121b, 131b, 141b, 151b, or 161b and the blanket cylinder 122b, 132b, 142b, 152b, or 162b for the other surface with the corresponding plate cylinder 123a, 123b, 133a, 133b, 143a, 143b, 153a, 153b, 163a or 163b and inking device 124a, 124b, 134a, 134b, 144a, 144b, 154a, 154b, 164a, or 164b, and the like, and a plurality of the printing units are capable of being coupled and installed. Therefore, the maximum number of colors required for printing can be easily set by changing the number of units to be installed.
(8) The distance by which the sheet is transported by the delivery chain 174 can be shortened in comparison to the case of a printing press of the simultaneous double-sided printing system as described in the aforementioned Patent Literature 1 and the like. Therefore, the degree of occurrence of damaging the sheet during transportation can be significantly suppressed.

### INDUSTRIAL APPLICABILITY

The banknote printing press according to the present invention is capable of printing sharp printing images on both surfaces of a sheet, and accordingly is very useful to be utilized in the manufacture of banknotes.

### REFERENCE SIGNS LIST

110 sheet feeding device
111 feeder board
112 feedboard
113 swing arm shaft pregripper
120 first printing unit
120a transfer cylinder for one surface
121a impression cylinder for one surface
122a blanket cylinder for one surface
123a plate cylinder for one surface
124a inking device for one surface
124aa1, 124aa2 ink fountain
124ab1, 124ab2 fountain roller
124ac1, 124ac2 ink ductor roller
124ad1 to 124ad4 oscillating roller
124ae roller train
125a dampening device for the other surface
120b transfer cylinder for the other surface
121b impression cylinder for the other surface
122b blanket cylinder for the other surface
123b plate cylinder for the other surface
124b inking device for the other surface
124ba1, 124ba2 ink fountain
124bb1, 124bb2 fountain roller
124bc1, 124bc2 ink ductor roller
124bd1 to 124bd4 oscillating roller
124be roller train
125b dampening device for the other surface
130 second printing unit
131a impression cylinder for one surface
132a blanket cylinder for one surface
133a plate cylinder for one surface
134a inking device for one surface
134aa1, 134aa2 ink fountain
134ab1, 134ab2 fountain roller
134ac1, 134ac2 ink ductor roller
134ad1 to 134ad4 oscillating roller
134ae roller train
135a dampening device for the other surface
130b transfer cylinder for the other surface
131b impression cylinder for the other surface
132b blanket cylinder for the other surface
133b plate cylinder for the other surface
134b inking device for the other surface
134ba1, 134ba2 ink fountain
134bb1, 134bb2 fountain roller
134bc1, 134bc2 ink ductor roller
134bd1 to 134bd4 oscillating roller
134be roller train
135b dampening device for the other surface
140 third printing unit
141a impression cylinder for one surface
142a blanket cylinder for one surface
143a plate cylinder for one surface
144a inking device for one surface
144aa1, 144aa2 ink fountain
144ab1, 144ab2 fountain roller
144ac1, 144ac2 ink ductor roller
144ad1 to 144ad4 oscillating roller
144ae roller train
145a dampening device for the other surface
140b transfer cylinder for the other surface
141b impression cylinder for the other surface
142b blanket cylinder for the other surface
143b plate cylinder for the other surface
144b inking device for the other surface
144ba1, 144ba2 ink fountain
144bb1, 144bb2 fountain roller
144bc1, 144bc2 ink ductor roller
144bd1 to 144bd4 oscillating roller
144be roller train
145b dampening device for the other surface
150 fourth printing unit
151a impression cylinder for one surface
152a blanket cylinder for one surface
153a plate cylinder for one surface
154a inking device for one surface
154aa1, 154aa2 ink fountain
154ab1, 154ab2 fountain roller
154ac1, 154ac2 ink ductor roller
154ad1 to 154ad4 oscillating roller
154ae roller train
155a dampening device for the other surface
150b transfer cylinder for the other surface
151b impression cylinder for the other surface
152b blanket cylinder for the other surface
153b plate cylinder for the other surface
154b inking device for the other surface
154ba1, 154ba2 ink fountain
154bb1, 154bb2 fountain roller
154bc1, 154bc2 ink ductor roller
154bd1 to 154bd4 oscillating roller
154be roller train
155b dampening device for the other surface
160 fifth printing unit
161a impression cylinder for one surface
162a blanket cylinder for one surface
163a plate cylinder for one surface
164a inking device for one surface
164aa1, 164aa2 ink fountain
164ab1, 164ab2 fountain roller
164ac1, 164ac2 ink ductor roller
164ad1 to 164ad4 oscillating roller
164ae roller train
165a dampening device for the other surface
160b transfer cylinder for the other surface
161b impression cylinder for the other surface
162b blanket cylinder for the other surface
163b plate cylinder for the other surface
164b inking device for the other surface
164ba1, 164ba2 ink fountain
164bb1, 164bb2 fountain roller
164bc1, 164bc2 ink ductor roller
164bd1 to 164bd4 oscillating roller
164be roller train
165b dampening device for the other surface
170 delivery device
170a transport cylinder
171 delivery cylinder
173 sprocket
174 delivery chain
175A to 175C delivery pile
176A to 176C release cam
177A, 177B elevating device
190 control device
191a checking camera for one surface
191b checking camera for the other surface

1-4. (canceled)

5. A banknote printing press for printing banknotes, comprising:
a printing section for one surface including an impression cylinder for one surface which holds and transports a sheet, a blanket cylinder for one surface which is in contact with the impression cylinder for one surface and which performs printing on one surface of the sheet, a plate cylinder for one surface which is in contact with the blanket cylinder for one surface, and ink supply means for one surface for supplying ink to the plate cylinder for one surface;
a printing section for the other surface including an impression cylinder for the other surface which is in contact with the impression cylinder for one surface of the printing section for one surface and which receives the sheet from the impression cylinder for one surface and holds and transports the sheet, a blanket cylinder for the other surface which is in contact with the impression cylinder for the other surface and which performs printing on the other surface of the sheet, a plate cylinder for the other surface which is in contact with the blanket cylinder for the other surface, and ink supply means for the other surface for supplying ink to the plate cylinder for the other surface; and
sheet delivery means disposed downstream of the printing section for the other surface in a transporting direction of the sheet and including a plurality of piling units on each of which the sheet is to be piled, wherein
each of the ink supply means for one surface of the printing section for one surface and the ink supply means for the other surface of the printing section for the other surface includes:
two ink fountains; an oscillating roller; and oscillation adjusting means for adjusting oscillation of the oscillating roller.

6. The banknote printing press according to claim 5, wherein
the printing section for one surface and .the printing section for the other surface are configured as a printing unit of one module, and
a plurality of the printing units are capable of being coupled.

7. The banknote printing press according to claim 5, further comprising:
checking means for one surface for checking a printing condition of the one surface of the sheet, the checking means for one surface being disposed downstream, in the transporting direction of the sheet, of a printing portion in the printing section for one surface that is located on the most downstream side in the transporting direction of the sheet; and
checking means for the other surface for checking a printing condition of the other surface of the sheet, the checking means for the other surface being disposed downstream, in the transporting direction of the sheet, of a printing portion in the printing section for the other surface that is located on the most downstream side in the transporting direction of the sheet.

8. The banknote printing press according to claim 5, further comprising:
plate changing means for one surface for changing a printing plate for the plate cylinder for one surface, the plate changing means for one surface being provided in the printing section for one surface; and
plate changing means for the other surface for changing a printing plate for the plate cylinder for the other surface, the plate changing means for the other surface being provided in the printing section for the other surface.
